(19) United States
(12) Patent Application Publication
(10) Pub. No.: US 2005/0223291 A1
(43) Pub. Date: Oct. 6, 2005

(54) Methods and apparatus to provide an execution mode transition

(76) Inventors: Vincent J. Zimmer, Federal Way, WA (US); Michael A. Rothman, Puyallup, WA (US)

Correspondence Address: GROSSMAN & FLIGHT LLC, Suite 4220, 20 North Wacker Drive, Chicago, IL, 60606-6357, US

(21) Appl. No.: 10/807,758

(22) Filed: Mar. 24, 2004

(51) Int. Cl. G06F 11/00

(52) U.S. Cl. 714/34

(57) ABSTRACT

Methods and apparatus to provide an execution mode transition are disclosed. One example method includes receiving in an operating system runtime environment a firmware code update to be implemented in a multiprocessor system, storing the firmware code update, and issuing an interprocessor interrupt to each processor of the multiprocessor system. The method further includes storing state information for each processor of the multiprocessor system, transitioning from an operating system runtime environment to a pre-operating system environment, and implementing the firmware code update in the pre-operating system environment. The state information is then read and restored to each processor to transition from the pre-operating system environment to an operating system runtime environment.

### TECHNICAL FIELD

The present disclosure pertains to computing systems and, more particularly, to methods and apparatus to provide an execution mode transition.

### BACKGROUND

Computing systems have become widely used for numerous purposes including business and entertainment. In fact, computing systems are now available in a number of different form factors including desktop, laptop/notebook, and server configurations. As is well known, today's desktops and laptops/notebooks typically include a single processor having associated memory and mass storage device such as a hard drive. By contrast, many of today's servers include a number of processors that are housed within one chassis to form a multiprocessor machine. In a server, the multiple processors execute multiple different threads or applications to support a number of clients that may access the server for data, communication, and processing functionality.

Computing systems operate using software and/or firmware that are compiled to operate on the processors of the computing systems. For example, in one typical scenario, computer software may be written on to a hard drive, or other mass storage, of a computing system and read into memory of the computing system so that the processor can execute the instructions out of the memory. Software may include productivity software such as word processors, spreadsheets, e-mail programs, and the like. Additionally, software may include an operating system (OS) that is executed by the processor to provide user interfaces through which the processor may be controlled or used. For example, presently-available operating systems include the Windows family of operating systems, Linux, and any other commercially available operating systems.

By contrast, firmware which may be used to provide a pre-operating system (pre-OS) environment, may be stored in a flash memory and executed before an operating system is booted. For example, firmware code may be used to provide a hardware interface such as the extensible firmware interface (EFI).

The complexity of today's software and firmware coupled with the rapid pace at which software and firmware is being developed makes it necessary for software and firmware to be updated on computing systems. For example, software updates may now be downloaded from the Internet, written to a hard drive on the computing system, and installed to operate as part of the program for which they were designed. For example, Microsoft frequently makes Windows updates available on line via their Internet webpage http://windowsupdate.microsoft.com.

In contrast to software upgrades, which may be written to hard disk and installed as part of a software program during OS runtime, firmware upgrades must be written into flash memory. The difficulty in upgrading flash with firmware updates is that the flash is locked after an OS has been booted (i.e., during OS runtime). Accordingly, while firmware updates may be downloaded during OS runtime, they may only be implemented in a pre-OS environment because the flash part is locked to prevent OS corruption of the firmware.

Prior techniques of performing firmware updates using downloaded information have been carried out on laptops, desktops, and other computing systems that support the Advanced Configuration and Power Interface (ACPI). As will be readily appreciated by those having ordinary skill in the art, the ACPI is a power management interface having a number of states designed to conserve power consumed by the computing system. To perform firmware updates, an ACPI compatible system has written updates to a predefined storage location during runtime and used a restart event such as an INIT/S3 ACPI state transition, which disables (turns of) all system components except for the system memory, which may be random access memory (RAM). In the S3 state, the flash memory is unlocked and the row address strobe (RAS) and column address strobe (CAS) are maintained on the system memory so that the memory retains its information. If the OS has previously written information to a pre-defined location before entering OS runtime, upon restart the processor operates in the pre-OS environment, which unlocks the flash memory, and writes the information from the predefined location into the unlocked flash memory, thereby updating the flash memory. After the flash memory has been updated, the OS runtime environment is resumed (i.e., the S3 mode transitions back to a fully operational mode).

While the foregoing process is suitable for use in systems supporting the ACPI, many servers and hand held devices such as personal digital assistants (PDAs) are unable to use the foregoing process because they do not support ACPI. For example, servers do not typically support ACPI because servers are designated to be operational in a nearly continuous manner with minimal downtime. Additionally, servers do not include separate power planes for the processing and memory functions as required by the ACPI specification to allow the memory to be powered while the processor is powered down. Accordingly, presently all updates to server firmware must be carried out by manually shutting down and restarting the server.

### BRIEF DESCRIPTION OF THE DRAWINGS

FIG. 1 is a block diagram of a networked computing system including a multiprocessor server on which the disclosed execution mode transition may be carried out.

FIG. 2 is a block diagram of a multiprocessor server, such as the multiprocessor server of FIG. 1.

FIG. 3 is a block diagram showing various operating environments of a multiprocessor server, such as the multiprocessor server of FIG. 2.

FIG. 4 is a flow diagram of a system start process that may be carried out by the multiprocessor server of FIGS. 1 and 2 to provide an execution mode transition.

FIG. 5 is a flow diagram of an OS process that may be carried out by the multiprocessor server of FIGS. I and 2 to provide an execution mode transition.

### DETAILED DESCRIPTION

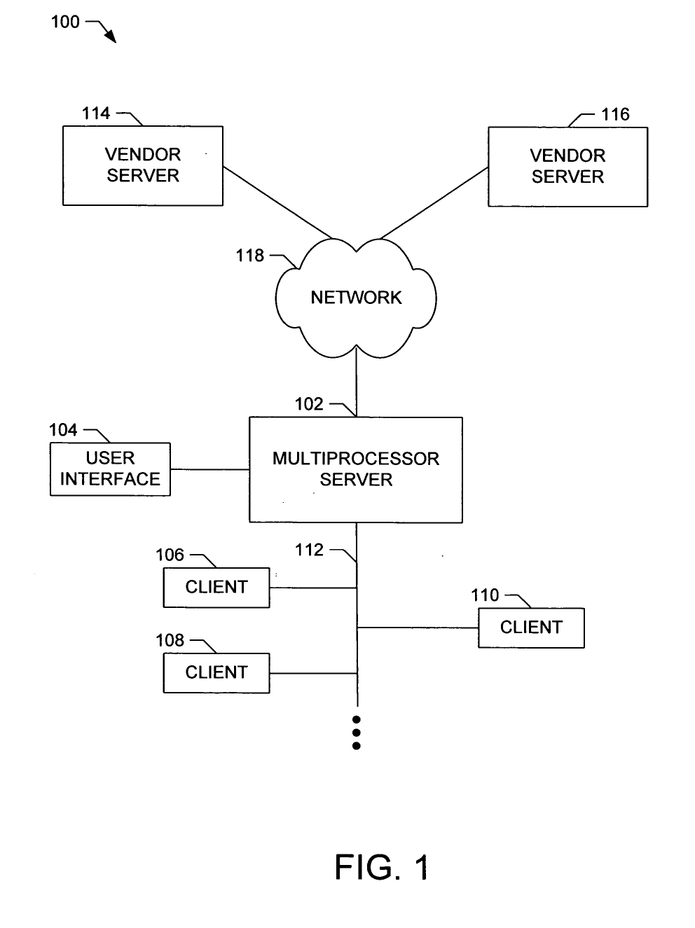

Turning now to FIG. 1, a network computing system 100 may include a multiprocessor server 102 having an associated user interface 104. The multiprocessor may be linked to a number of clients 106, 108, 110 via a first network 112. The multiprocessor server 102 may further be connected to one or more vendor servers 114, 116 through a second network 118.

In such an arrangement, the multiprocessor server 102 may provide data, processing, or other services to the clients 102, 108, 110. For example, the multiprocessor server 102 may act as a host for documents or data that are manipulated by the clients 106, 108, 110. Periodically, it may be necessary for a network administrator to update firmware of the multiprocessor server 102. To perform such an update, the network administrator utilizes the user interface 104 to control the multiprocessor server 102 to download firmware updates from one more of the vendor servers 114, 116 via the network 118. This downloading takes place during OS runtime of the multiprocessor server 102.

As disclosed below, the multiprocessor server 102 may utilize a data transfer portion of memory, which is referenced to hereinafter as a mailbox, to transition from OS runtime to a pre-OS environment in which firmware updates may be written to a flash memory. After the updates are made, the multiprocessor system is transitioned from the pre-OS environment back to the OS runtime environment in the same state in which the OS runtime environment was left. As described below, this functionality is carried out by preserving CPU state information from all the processors of the multiprocessor server 102.

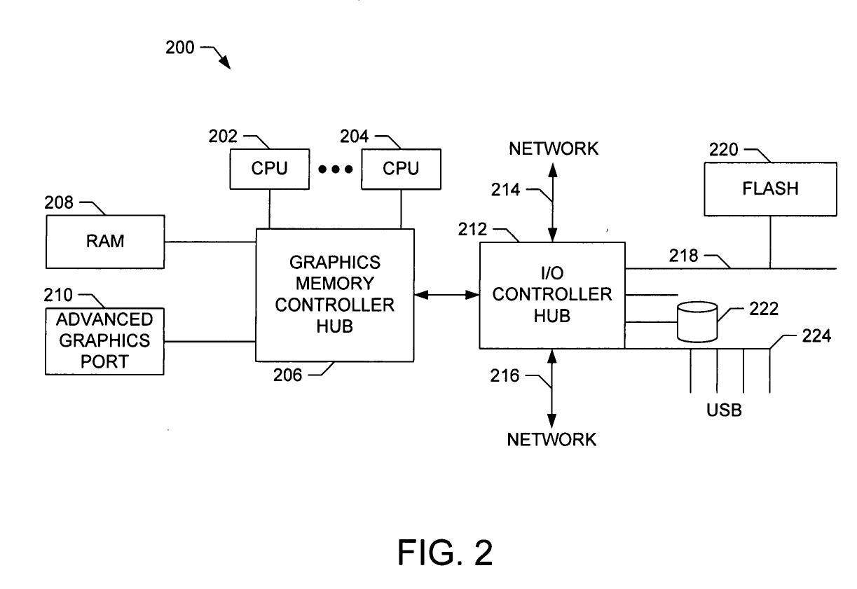

The multiprocessor server 102 may be implemented using any suitable server hardware, such as, for example, an Intel-architecture server like the Itanium and/or an 8-way Xeon platform server. Further detail regarding one particular multiprocessor server implementation is provided in conjunction to FIG. 2 below.

The user interface 104 may be implemented using any standard server interface such as, for example, a display screen and a keyboard and/or a mouse. Alternatively, the multiprocessor server 102 may be remotely managed without the use of the user interface 104. For example, the multiprocessor server may be administered by one or more of the clients 106, 108, 110 or by another entity connected to one of the first and second networks 112, 118.

The clients 106, 108, 110 may be implemented using conventional computing systems such as Pentium-based desktop or notebook computers that may be coupled to the multiprocessor server 102 via network 112. The network 112 may be implemented using an Ethernet, a wireless network, or any suitable data communication network configured to allow the clients 106, 108, 110 to exchange information with the multiprocessor server 102.

The vendor servers 114, 116 may be implemented by any computing device that is able to host information for download over the network 118. For example, the vendor servers 114, 116 may be implemented using a multiprocessor server, a single processor server, a desktop computer, or any other suitable device. The vendor server 114, 116 may host Internet web pages that provide links for downloading firmware patches or upgrades from the vendor servers 114, 116 to the multiprocessor server 102. Accordingly, the multiprocessor server 102 may access the vendor servers 114, 116 to download information there from.

The network 118 that links the multiprocessor server 102 to the vendor servers 114, 116 may be implemented using the Internet, a local area network (LAN), a wide area network (WAN) or any other suitable network through which information may be exchanges. Of course, the network 118 may be formed of any number of different media, such as the Internet, dial-up connections, wireless connections, etc.

As shown in FIG. 2, a multiprocessor server 200, which may be used to implement the multiprocessor server 102 of FIG. 1, includes a plurality of central processing units (CPUs) 202, 204. The CPUs 202, 204 are coupled to a graphics memory hub controller (GMCH) 206 to which RAM 208 and an advanced graphics port 210 are coupled. The GMCH 206 is also coupled to an input/output controller hub (IOCH) 212. The IOCH 212 supports input and output functionality and is therefore coupled to one or more networks (e.g., the networks 112, 118 of FIG. 1) through communication lines 214, 216. The IOCH 212 may include a firmware hub 218 to which a flash memory 220 is coupled. The IOCH 212 may also be coupled to a hard drive 222 and may also support a universal serial bus 224.

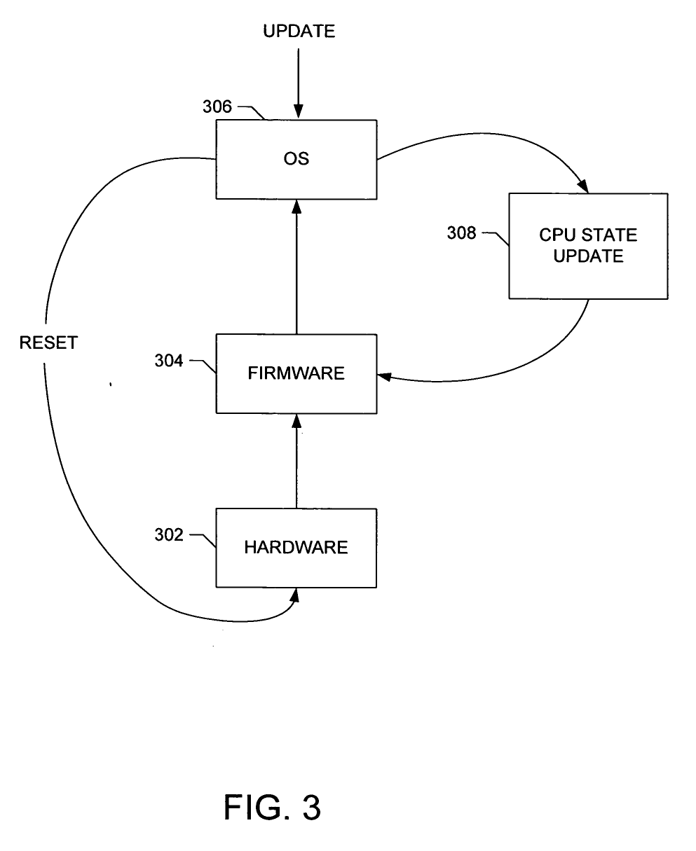

FIG. 3 illustrates relationships between various operating environments as a processor system, such as the multiprocessor server 102 of FIG. 1, boots from an OFF state or recovers from a reset. At the base level of operation, hardware is powered up and initialized (block 302). Initialization may include clearing registers, resetting pointers, etc. After the hardware is initialized (block 302), a pre-OS, or firmware, environment is entered (block 304). In the firmware environment, a firmware interface such as a basic input-output system (BIOS) or the extensible firmware interface (EFI) prepares the system for operating system boot. As will be readily appreciated to those having ordinary skill in the art, firmware such as BIOS defines the capabilities of the hardware system before the hardware system is able to use external data, such as data from a disk. For example, the firmware may contain all the code required to control the keyboard, display screen, disk drives, serial communications, and a number of miscellaneous functions. Many systems, such as the multiprocessor server 200 of FIG. 2, have firmware stored in the flash memory 220 so that the firmware may be updated as needed. However, as noted above, the flash memory 220 may be unlocked only when the multiprocessor system 200 is in a pre-OS environment.

As the firmware executes in the firmware environment (block 304), the processor system becomes ready to boot an OS. The transition from the firmware environment (block 304) to an OS runtime environment (block 306) occurs when a firmware instruction calls an OS loader. Such a firmware instruction is the last instruction that will be executed by the processor in the pre-OS environment. When the OS loader is called, the OS is booted by the processor and the processor will continue to operate in the OS runtime state (block 306). In a situation in which a server is being booted, the server may have an OS runtime version of Windows 2000-Server, or any other suitable environment.

As shown in FIG. 3, during OS runtime (block 306), a server may download firmware updates, upgrades, patches, or other software or firmware components that need to be stored within the flash memory (e.g., the flash memory 220 of FIG. 2). However, during OS runtime, the flash memory cannot be accessed because it is locked. Accordingly, as disclosed herein, the OS runtime (block 306), stores the downloaded update in a data store referred to herein as a mailbox (block 308). Additionally, the OS stores information representative of the CPU states in the mailbox (block 308).

After the mailbox is filled with CPU state and update information (block 308), the OS issues a system reset, which causes the operating environment to transition from the OS runtime (block 306) to the hardware or other pre-OS state (block 302). The hardware initialization takes place as previously described and the system transitions to firmware control (block 304). The firmware, prior to calling the OS loader, checks the mailbox (block 308) to determine if state and update information is available. If such information is available, the firmware implements the update, which may include writing one or more instructions to the flash memory. After the update has been implemented, the CPU state information is written to the system memory so that the prior OS runtime state may be recreated. Because the state information includes information that puts the hardware back into the OS runtime state (block 306), there is no need to call the OS loader.

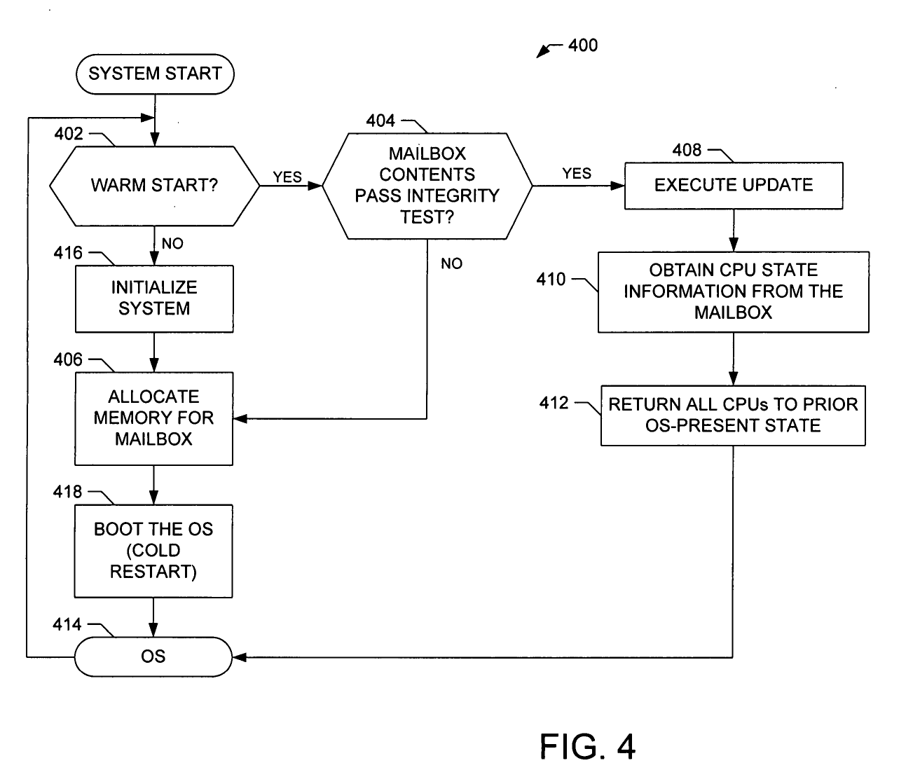

Turning now to FIG. 4, a system start process 400 is shown as a flow diagram including a number of blocks that represent instructions or sets of instructions or programs. The process 400 is carried out in a pre-OS, or preboot, environment. The instructions may be implemented in software or firmware that may be stored in a memory, such as the flash memory 220 of FIG. 2. The instructions may be loaded from the memory and executed by one or more processing units, such as the CPUs 202, 204 of FIG. 2. However, some of the blocks of the process 400 may be performed manually and/or by some other device. Additionally, although the process 400 is described with reference to the flowchart of FIG. 4, persons of ordinary skill in the art will readily appreciate that many other methods of performing the process 400 may be used. For example, the order of many of the blocks may be altered, the operation of one or more blocks may be changed, blocks may be combined, and/or blocks may be eliminated.

The process 400 may be carried out by a processing unit, such as one or more of the CPUs 202, 204 of FIG. 2, upon a cold restart such as a power-up of the processing unit and/or upon the receipt of a warm restart command such as a cf9h command. The process 400 begins its execution by determining if the processing unit is experiencing a warm start (block 402). A warm start is a system restart that occurs without the loss of information stored in processing unit memory such as the RAM 208 of FIG. 2. The determination of whether the processing unit is experiencing a warm start may be made by, for example, examining a state of a latch on an IOCH, such as the IOCH 212 of FIG. 2, because the latch on the IOCH is configured to convey the reason for which the processing unit was reset. For example, the latch may convey that the processing unit was placed into a hibernate mode from which recovery is a warm start, or may indicate that the processing unit was shut down through a power cycle from which the recovery is a cold start.

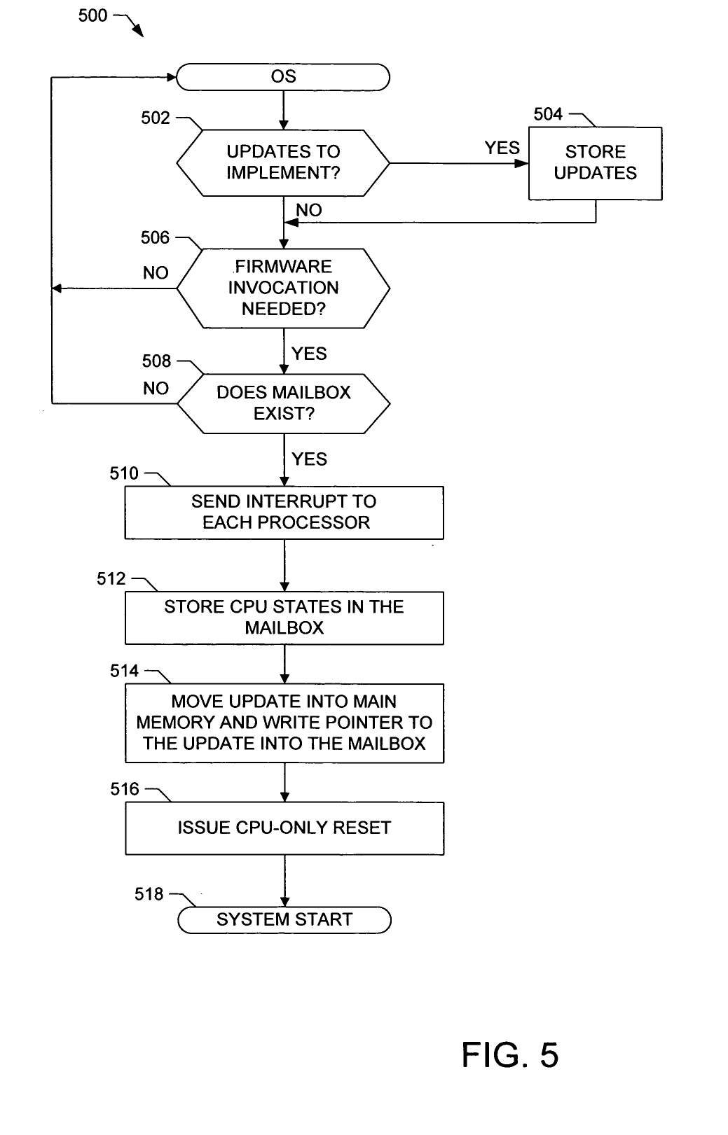

It is possible that the warm start was caused by the OS writing information to a mailbox and issuing a warm restart command to the CPU to cause the CPU to warm restart, as described below in conjunction with FIG. 5. If the process 400 determines that the start is a warm start (block 402), the process 400 determines if the contents of the mailbox pass an integrity test (block 404). The integrity test performed on the contents of the mailbox may include any data integrity test process. For example, the integrity test may include determining if the contents of the mailbox are signed, if the contents pass a cyclic redundancy check (CRC) and/or have a proper checksum value, or any other data integrity test. Additionally, the integrity check may be performed on information not residing in the mailbox, but having a pointer residing in the mailbox. For example, a pointer to downloaded updates may be stored in the mailbox and the updates themselves may be integrity checked by following the pointer in the mailbox. Details regarding how the information was placed in the mailbox are provided below in conjunction with FIG. 5.

If the mailbox contents do not pass the integrity check (block 404), it may be because the contents of the mailbox are corrupt or it may be because the mailbox has not been previously configured or allocated in memory. Accordingly, if the integrity check is not passed (block 404), the process may allocate memory for a mailbox to be subsequently used (block 406). The memory allocation may be effectuated by firmware reservation of physical memory, the use of a firmware memory map such as an extensible firmware interface (EFI) memory map, or any other means. The address of the mailbox may be described by a pointer in ACPI, an EFI variable, or some other technique. The mailbox may have a fixed organization including records to describe all of the CPU states and a pointer to a linked list of additional physical memory pages.

Alternatively, if the mailbox contents pass the integrity test (block 404), the update contained in the mailbox may be executed (block 408). The update that is executed may be, for example, a firmware update that necessitates the writing of information into flash memory, such as the flash memory 220 of FIG. 2. The update is executed prior to the loading of an OS, at which point the flash memory is unlocked, so information may be written to the flash memory.

After the update is executed (block 408), the process 400 obtains the previously-stored state of the processing unit from the mailbox (block 410). The previously-stored state of the processing unit may include the contents of CPU memory and registers from a prior point in time at which the update was selected to be executed and at which the CPU was reset. Further detail regarding CPU state information and how it was placed in the mailbox is provided below in conjunction with FIG. 5.

After the CPU state information is obtained from the mailbox (block 410), the process 400 loads the state information into memory (e.g., the RAM 208 of FIG. 2) to return all CPUs to the prior OS-runtime state (block 412). In addition to loading state information into memory, the state information may also be loaded back into registers, counters, etc. The goal of loading the state information from the mailbox back into memory is to restore the CPUs to the states in which they were operating prior to the restart used to implement any updates needed to the system. After the state information for the CPUs has been restored (block 412), the CPUs (e.g., the CPUs 202, 204 of FIG. 2) will be in an OS-runtime state and, therefore, the process 400 ends and an OS process (block 414) is commenced.

Returning back to the description associated with block 402, if the process 400 determines through examination of an IOCH port or through some other means that the process 400 was not commenced as a warm start but, rather, was a cold start or any other start, the process initializes the system (block 416). As will be readily appreciated by those having ordinary skill in the art, the initialization (block 416) may include resetting registers or memory to known values, preparing I/O ports to receive and transmit communication, establishing communications that enable the CPUs to communicate with any peripheral, etc.

After the system is initialized (block 416), memory is allocated for the mailbox as previously described (block 406). After memory is allocated for the mailbox (block 406), the process 400 boots an OS (block 418). As will be readily appreciated by those having ordinary skill in the art, the OS boot (block 418) may be commenced through the calling of an OS loader or any other suitable software tool that may be used to initiate the loading of an OS. The boot is treated like a cold restart. Once the OS is loaded (block 418), the process 400 ends and the CPUs begin operating in the OS process (block 414).

FIG. 5 is a flow diagram of an OS process 500 including a number of blocks that represent instructions or sets of instructions or programs carried out during OS runtime. The instructions may be implemented in software or firmware that may be stored in a memory, such as the hard drive 222 or the RAM 208 of FIG. 2. The instructions may be loaded from the memory and executed by one or more processing units, such as the CPU 202, 204 of FIG. 2. However, some of the blocks of the process 500 may be performed manually and/or by some other device. Additionally, although the process 500 is described with reference to the flowchart of FIG. 5, persons of ordinary skill in the art will readily appreciate that many other methods of performing the process 500 may be used. For example, the order of many of the blocks may be altered, the operation of one or more blocks may be changed, blocks may be combined, and/or blocks may be eliminated.

The OS process 500 includes normal OS operations that take place in an OS runtime environment. However, in addition to the conventional OS operations, the OS process may determine if there are updates to implement (block 502). The updates may include firmware instructions to be written into the flash memory such as the flash memory 220 of FIG. 2. The determination that there are updates to implement may be made, for example, by a user accessing a vendor server (e.g., one or more of the vendor servers 114, 116 of FIG. 1) and determining if system updates are available for downloading. Alternatively, the user may navigate to vendor websites or may possess updates on media such as a compact disk (CD) or other computer readable media that may be read by the computing system executing the OS process 500. In some implementations, the OS runtime software may automatically determine if updates are available for implementation through the use of one or more software tools that may, for example, monitor vendor websites for software or firmware updates.

If updates are available (block 502), the process 500 stores the updates (block 504) in memory. For example, the updates may be stored in a memory (e.g., the RAM 208 or the hard drive 222 of FIG. 2) and a pointer to the updates may be written to the mailbox. Alternatively or additionally, the updates may be stored directly into a mailbox that has been previously allocated. During OS runtime, the flash memory (e.g., the flash memory 220 of FIG. 2) of the processing system running the OS process 500 is locked and, therefore, updates may not be written to flash memory during OS runtime.

After the updates are stored (block 504) or if there are no updates to implement (block 502), the process 500 determines if a firmware invocation is needed (block 506). Some of the updates stored by the process 500 may be software updates that do not include information or data to be written to the flash memory, such updates do not require firmware invocation because these updates may be made during OS runtime. However, some stored updates may require firmware invocation because the updates include information to be written to the flash memory. If firmware invocation is not needed (block 506), the process 500 continues to operate in its normal OS runtime mode in which the updates may be implemented without the need for pre-OS firmware intervention.

Alternatively, if a firmware invocation is needed (block 506), the process 500 determines if a mailbox exists (block 508). The mailbox may be allocated as described above in conjunction with FIG. 4. For example, the mailbox may be a portion of memory reserved by the pre-OS environment using a memory map such as an extensible firmware interface (EFI) memory map. Alternatively, the mailbox may be allocated in memory by the OS.

If the mailbox does not exist (block 508), the process 500 continues its normal operation and the firmware invocation that is needed will be carried out on the next system restart. If, however, the OS determines that the mailbox exists (block 508), the OS sends an interprocessor interrupt to each processor (block 510). For example, with reference to FIG. 2, if the CPU 202 is running the process 500, the CPU 202 will send an interprocessor interrupt to the CPU 204 or any other processor in the system 200. The interprocessor interrupt causes each of the processing units (e.g., the CPUs 202, 204) to halt processing so that the states of the processing units may be stored and used in the future to restore these processing units to their former states.

After the interprocessor interrupt has been issued (block 510), the process 500 stores in the mailbox the states of the CPUs that have been interrupted (block 512). The states of the CPUs may be represented by storing the general-purpose CPU states that are visible to software. These states may be, for example, represented by general-purpose registers in the 32-bit Intel architecture (IA32), such as a general purpose register (EAX), memory-management unit registers such as a global descriptor table register (GDTR), and one or more instructions pointers such as the extended instruction pointer (EIP), etc. Additionally, the state of the processing units may be represented by information related to software virtual machines, such as an EFI byte count (EBC), a global descriptor table (GDT) that is stored in memory, etc. In the alternative, the state information of the processing units may be written to a location other than the mailbox and a pointer to the stored state information may be written into the mailbox so that when the pre-OS environment accesses the mailbox, the location of the state information may be determined therefrom.

After the state recovery information is written into the mailbox (block 512), the update information is moved from its prior location where it was stored by the process 500 at block 504 into main memory, such as the RAM 208 of FIG. 2, and a pointer to the update information is written into the mailbox (block 514). Alternatively, the process 500 at block 504 may have stored in the update information directly into the main memory, in which case it would be unnecessary to carry out block 514.

After the state information has been written into the mailbox (block 512) and, if needed, the update information has been moved into main memory (block 514), the process 500 causes the processing unit (e.g., the CPU 202) to issue a CPU-only reset to all processing units so that all processing units are reset or experience a warm start (block 516). In one particular example, the CPU executing the process 500 may issue a cf9h command that is received by an IOCH (e.g., the IOCH 212 of FIG. 2). In a known manner, the IOCH, upon receiving the cf9h command instructs each of the CPUs coupled to the GMCH (e.g., the GMCH 206) to perform a warm restart. The warm restart command causes each of the CPUs to enter a system start process (block 518), one example of which was described above in connection with FIG. 4.

Although the foregoing disclosed example systems including, among other components, software or firmware executed on hardware, it should be noted that such systems are merely illustrative and should not be considered as limiting. For example, it is contemplated that any or all of these hardware, software, and/or firmware components could be embodied exclusively in dedicated hardware, exclusively in software, exclusively in firmware, or in some combination of hardware, firmware, and/or software. Further, while the following discloses example systems in which firmware residing in computing system flash is updated, those having ordinary skill in the art will readily recognize that the disclosed methods and apparatus may be used to perform any code upgrade, be it firmware, software, or otherwise. Accordingly, while the following describes example systems, persons of ordinary skill in the art will readily appreciate that the examples are not the only way to implement such systems. In fact, the scope of coverage of this patent is not limited to the foregoing disclosure. On the contrary, this patent covers every apparatus, method and article of manufacture fairly falling within the scope of the appended claims either literally or under the doctrine of equivalents.

1. A method comprising:
receiving in an operating system runtime environment a firmware code update to be implemented in a multiprocessor system;
storing the firmware code update;
issuing an interprocessor interrupt to each processor of the multiprocessor system;
storing state information for each processor of the multiprocessor system; and
transitioning from the operating system runtime environment to a pre-operating system environment.

2. A method as defined by claim 1 further comprising:
implementing the firmware code update in the pre-operating system environment;
reading the state information for each processor of the multiprocessor system; and
restoring the state information to each processor of the multiprocessor system, thereby transitioning from the pre-operating system environment to the operating system runtime environment.

3. A method as defined by claim 2, further comprising:
determining, in the pre-operating system environment, if a processing unit has been instructed to carry out a warm start; and
determining, in the pre-operating system environment, if a predefined storage location includes the firmware code update.

4. A method as defined by claim 2, further comprising determining if the state information passes an integrity check.

5. A method as defined by claim 2, further comprising allocating memory for storage of the firmware code update and the state information.

6. An article of manufacture comprising a machine-accessible medium having a plurality of machine accessible instructions that, when executed, cause a machine to:
receive in an operating system runtime environment a firmware code update to be implemented in a multiprocessor system;
store the firmware code update;
issue an interprocessor interrupt to each processor of the multiprocessor system;
store state information for each processor of the multiprocessor system; and
transition from the operating system runtime environment to a pre-operating system environment.

7. An article of manufacture as defined by claim 6, wherein the plurality of machine accessible instructions, when executed, cause the machine to:
implement the firmware code update in the pre-operating system environment;
read the state information for each processor of the multiprocessor system; and
restore the state information to each processor of the multiprocessor system, thereby transitioning from the pre-operating system environment to the operating system runtime environment.

8. An article of manufacture as defined by claim 7, wherein the plurality of machine accessible instructions, when executed, cause the machine to:
determine, in the pre-operating system environment, if a processing unit has been instructed to carry out a warm start; and
determine, in the pre-operating system environment, if a predefined storage location includes the firmware code update.

9. An article of manufacture as defined by claim 7, wherein the plurality of machine accessible instructions, when executed, cause the machine to determine if the state information passes an integrity check.

10. An article of manufacture as defined by claim 7, wherein the plurality of machine accessible instructions, when executed, cause the machine to allocate memory for storage of the firmware code update and the state information.

11. A method comprising:
receiving in an operating system runtime environment a firmware code update to be implemented in a multiprocessor system;
storing the firmware code update in a first defined storage location;
issuing an interprocessor interrupt to each processor of the multiprocessor system;
storing operating system runtime state information for each processor of the multiprocessor system in a second defined storage location;
transitioning from the operating system runtime environment to a pre-operating system environment;
determining if a warm start has been requested;
reading the firmware code update from the first defined storage location;
implementing the firmware code update in the pre-operating system environment;
reading from the second defined storage location the operating system runtime state information for each processor of the multiprocessor system; and
restoring the operating system runtime state information to each processor of the multiprocessor system, thereby transitioning from the pre-operating system environment to the operating system runtime environment.

12. A method as defined by claim 11, wherein transition from the operating system runtime environment to the pre-operating system environment comprises a processor-only reset.

13. A method as defined by claim 11, comprising performing an integrity check on the operating system runtime state information and the firmware code update.

14. A method as defined by claim 11, wherein the firmware code update is downloaded from an Internet website.

15. A method as defined by claim 11, comprising allocating a memory location to define the first defined storage location and writing a pointer to the first defined storage location into the second defined storage location.

16. An article of manufacture comprising a machine-accessible medium having a plurality of machine accessible instructions that, when executed, cause a machine to:
receive in an operating system runtime environment a firmware code update to be implemented in a multiprocessor system;
store the firmware code update in a first defined storage location;
issue an interprocessor interrupt to each processor of the multiprocessor system;
store operating system runtime state information for each processor of the multiprocessor system in a second defined storage location;
transition from the operating system runtime environment to a pre-operating system environment;
determine if a warm start has been requested;
read the firmware code update from the first defined storage location;
implement the firmware code update in the pre-operating system environment;
read from the second defined storage location the operating system runtime state information for each processor of the multiprocessor system; and
restore the operating system runtime state information to each processor of the multiprocessor system, thereby transitioning from the pre-operating system environment to the operating system runtime environment.

17. An article of manufacture as defined by claim 16, wherein the plurality of machine accessible instructions, when executed, cause the machine to transition from the operating system runtime environment to the pre-operating system environment by issuing a processor-only reset.

18. An article of manufacture as defined by claim 16, wherein the plurality of machine accessible instructions, when executed, cause the machine to perform an integrity check on the state information and the firmware code update.

19. An article of manufacture as defined by claim 16, wherein the plurality of machine accessible instructions, when executed, cause the machine to download the firmware code update from an Internet website.

20. An article of manufacture as defined by claim 16, wherein the plurality of machine accessible instructions, when executed, cause the machine to allocate a memory location for storage of the state information and a pointer to the firmware code update.
